(19) United States
(12) Patent Application Publication
(10) Pub. No.: US 2009/0174557 A1
(43) Pub. Date: Jul. 9, 2009

(54) COMPACT FLEXIBLE HIGH GAIN ANTENNA FOR HANDHELD RFID READER

(75) Inventors: Pavel Nikitin, Seattle, WA (US); KVS Rao, Bothell, WA (US); For S. Lam, Bothell, WA (US); Steven Schatz, Cedar Rapids, IA (US); Jerry Johnson, Cedar Rapids, IA (US)

Correspondence Address: PERKINS COIE LLP;PATENT-SEA, P.O. BOX 1247, SEATTLE, WA, 98111-1247, US

(73) Assignee: Intermec IP Corp.

(21) Appl. No.: 11/968,972

(22) Filed: Jan. 3, 2008

(51) Int. Cl. G08B 13/14; H01Q 17/00

(52) U.S. Cl. 340/572.7; 29/601

(57) ABSTRACT

A compact flexible high gain antenna is disclosed which includes a co-planar array of at least three substantially parallel main conducting antenna elements, a reflector, a driven element, and a director. Each of these elements may be terminated on the ends by a stub element, and the reflector and the director may include an intermediate meander element. Stub elements capacitively load the antenna, while meander elements inductively load the antenna, and the loading affects the resonant frequency of the antenna. The conducting antenna elements may be affixed to a flexible dielectric substrate and may be bent or curved into different compact shapes, suitable for fitting manufacturing form factors for a handheld RFID reader. The antenna has a high directional gain which results in a longer operating range.

### TECHNICAL FIELD

The following relates generally to antennas for RFID readers.

### BACKGROUND

Hand-held radio frequency identification (RFID) readers must be sufficiently compact and lightweight for a user to easily wield. Thus, conventional hand-held RFID readers typically use small antennas which do not provide very high gain. Because the gain of an RFID reader's antenna is proportional to the square root of the gain of the RFID reader's antenna, current handheld RFID readers have a limited range.

There is a need for a system that overcomes the above problems, as well as providing additional benefits. Overall, the above examples of some related systems and associated limitations are intended to be illustrative and not exclusive. Other limitations of existing or prior systems will become apparent to those of skill in the art upon reading the following Detailed Description.

### BRIEF DESCRIPTION OF THE DRAWINGS

Examples of a compact flexible high gain antenna for handheld RFID readers are illustrated in the figures. The examples and figures are illustrative rather than limiting. The antenna is limited only by the claims.

FIG. 1 is a diagram showing an example of a compact high gain antenna design for handheld RFID readers with examples of stub elements and meander elements.

FIG. 2 is a graph showing an example of the effects of modifying antenna parameters on the performance of the antenna.

FIG. 3 depicts examples of different shapes a flexible high gain antenna may assume.

FIG. 4 depicts examples of how to modularly construct a flexible high gain antenna.

FIG. 5 shows an example of a compact high gain antenna suitable for operating with cross-polarization or circular polarization.

FIG. 6A shows an example of how to feed a compact high gain antenna to obtain cross-polarization.

FIG. 6B shows an example of how to feed a compact high gain antenna to obtain circular polarization.

FIG. 6C is a flow chart illustrating an example of a method of implementing an antenna with cross-polarization.

FIG. 7 is a diagram showing an example of a two-dimensional configuration for a compact high gain antenna.

FIG. 8 is a diagram showing an example of a two-dimensional configuration for a compact high gain antenna.

FIG. 9 depicts an example of a prototype of a compact flexible high gain antenna in a flat configuration.

FIG. 10 depicts an example of a prototype of a compact flexible high gain antenna folded and installed on an RFID reader.

FIG. 11 compares the gain curve as a function of frequency of a compact flexible high gain antenna (labeled as IP30) to that of a log-periodic antenna (labeled as Sinclair).

FIG. 12 depicts a block diagram of an RFID reader.

### DETAILED DESCRIPTION

Described in detail below is a compact high gain antenna. The antenna generates directional gain at RF frequencies and includes an array of main parallel conducting elements. These elements may be terminated with stub elements or include meander elements which shift the resonant frequency of the antenna. The antenna may be formed upon a flexible substrate, thus the antenna may be operated in a bent or curved shape and still maintain a high gain.

Various aspects of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the invention. Certain terms may even be emphasized below; however, any terminology intended to be interpreted in any restricted manner will be overtly and specifically defined as such in this Detailed Description section.

RFID readers transmit a radio frequency signal that is received by all RFID tags within range and tuned to the RFID reader's transmission frequency. Direct line-of-sight is not required between the reader and the tags, but the range of the RF reader is limited by the maximum gain of the reader's antenna. A higher gain antenna results in a longer operating range.

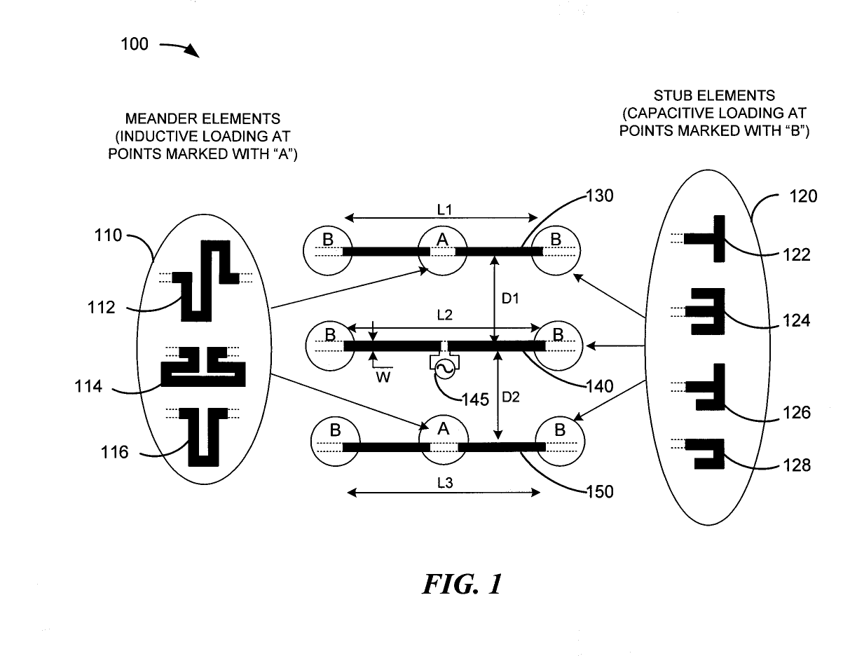

An example 100 of a two-dimensional configuration of a compact flexible high gain antenna for a handheld RFID reader disclosed herein is shown in FIG. 1. The antenna includes a conducting driven element 140 and two conducting elements 130 and 150, substantially parallel to, substantially co-planar with, and located on either side of the driven element 140. In operation, the conducting elements of the antenna should be mounted on a non-conducting dielectric material. While the antenna array may be constructed with just one conducting element parallel to the driven element, the resulting gain of the antenna is low, and thus the range of operation of the RFID reader is not very far. The antenna may also include more than three substantially parallel antenna elements which produces a higher gain antenna. Other antenna configurations include various elongated rectangular or elliptical loops as directors or reflectors. The directors and reflectors may also be composed of several individual elements lined up end to end in a row with spaces in between elements instead of one long single element. However, the tradeoff is that the antenna array would occupy a larger area as a result of the additional elements.

A feedpoint is coupled to the center of driven element 140 in the antenna where an alternating voltage 145 from an RF generating circuit may be applied at a suitable frequency of operation for the RFID reader. The alternating voltage generates alternating currents in the conducting elements 130, 140, and 150 of the antenna which then radiate electromagnetic fields. Typical alternating voltage frequencies are in the radio frequency band and may range from approximately 860 MHz to 960 MHz. However, the compact high gain antenna may also be used in other frequency ranges such as the 2.45 GHz microwave frequency band.

For example, the antenna may be a Yagi-Uda antenna. Yagi-Uda antennas are known in the art for their ability to provide directional high gain through the use of a two-dimensional array of conductive elements, including a driven element and closely coupled parasitic elements, usually a reflector and one or more directors. The driven element is fed from the center and operated at an appropriate radio frequency. The lengths of the elements in a Yagi-Uda antenna are approximately half of the wavelength at which the antenna array is driven, with the reflector being slightly longer than the driven element, and the one or more directors being slightly shorter than the driven element. The antenna is directional along the axis perpendicular to the dipole in the plane of the array of elements.

The direction in which the antenna 100 will have maximum gain will be along the axis perpendicular to the driven element 140 in the plane of the antenna array elements, from the reflector towards the director. This antenna configuration has linear polarization.

The ends of the substantially parallel antenna elements 130, 140, and 150, marked by the letter B, may be terminated by stub elements. Four examples of stub elements 122, 124, 126, and 128 are shown in the oval 120 on the right in FIG. 1. The impedance of the antenna is dependent upon the permittivity of the dielectric material upon which the antenna is mounted. The stub elements may be used to capacitively load the antenna elements 130, 140, 150 to change the antenna's impedance, and changes in the impedance of the antenna result in shifts of the resonant frequency of the antenna. Thus, selecting different configurations of the stub elements to terminate the ends of the antenna elements 130, 140, 150 will affect the antenna's resonant frequency. In general, the stub elements should not increase the length of any of the antenna elements 130, 140, and 150 by more than 30%.

The middle portion of one or both of the antenna elements 130 and 150, marked by the letter A in FIG. 1, may also include meander elements. Meander elements are used to increase the length of the main antenna elements. At high frequencies such as in the RF frequency range, increasing the length of the antenna array elements increases the inductance of the array. Thus, for the antenna array to resonate at a desired operating frequency, appropriate lengths of meander elements may need to be inserted into the main antenna elements.

Three basic examples of meander elements 112, 114, and 116 are shown in the oval 110 on the left in FIG. 1. Meander elements include narrow, closely-spaced loops of conducting material which effectively increase the length of the main antenna element because portions of the meander elements which are perpendicular to the main antenna element lie very close to another portion of the same meander element which is also perpendicular to the main antenna element. However, the currents flowing in the two neighboring perpendicular portions of the same meander element flow in opposite directions. Thus, the effects of radiation patterns generated by these matched currents flowing in opposite directions are canceled in the far field. The portions of the meander elements which contribute to radiation patterns in the far field are the portions which are parallel to the main antenna elements and thus, effectively increase the length of the main antenna elements.

The stub elements 122, 124, 126, and 128 and meander elements 112, 114, and 116 may be formed with curved corners rather than sharp corners to prevent large local electric fields. However, although the radiation pattern in the far field of the RFID reader, where the RFID tags to be read will be located, may change based upon the curvature of the corners of the stub and meander elements, the far field gain will remain largely the same. One skilled in the art will understand that other stub element configurations may be used including, but not limited to, combinations of one or more of the stub elements 122, 124, 126, and 128 and variations in lengths of the sections of the stub elements 122, 124, 126, and 128, and that other meander element configurations may be used including, but not limited to, combinations of one or more of the meander elements 112, 114, and 116 and variations in lengths of the sections of the meander elements 112, 114, and 116. Also, one or more of the stub and meander element configurations may be flipped 1800 about the main conducting antenna element.

Relevant parameters in the antenna design example shown in FIG. 1 are D1, D2, L1, L2, L3, and W. D1 is the distance between the antenna element 130 and the driven element 140, and D2 is the distance between the driven element 140 and the antenna element 150. L1, L2, and L3 are respectively the lengths of the main antenna elements 130, 140, and 150. Each of these lengths are measured to the edge of the physical length of any terminating stub elements, although the stub element may be electrically longer due to part of the stub element wrapping back around, such as in stub elements 124, 126, and 128. Thus, L1, L2, and L3 include the length of any meander elements but not the wrap-around length of any stub elements. W is the thickness of each of the antenna elements 130, 140, and 150, the stub elements 122, 124, 126, and 128, and the meander elements 112, 114, and 116. W is usually in the range from 1 to 10 mm. If W is much less than 1 mm, the resistive loss may become too high, and if W is much greater than 10 mm, the elements of the antenna may cover an area that is not sufficiently compact. One skilled in the art will recognize that different thicknesses may be chosen for different elements of the antenna. By selecting appropriate values for the parameters D1, D2, L1, L2, L3, and W together with the shapes of the loading stub and meander elements, the antenna's performance may be designed for particular applications.

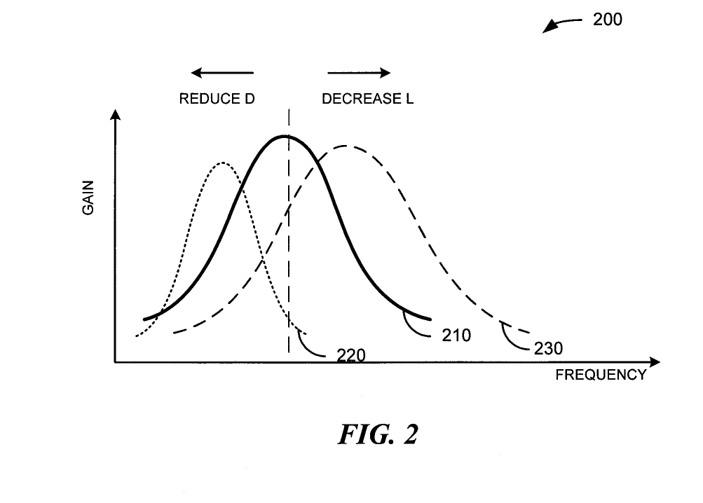

FIG. 2 shows a qualitative graph 200 of the gain as a function of frequency of the antenna example shown in FIG. 1 for three different sets of parameter values. For the baseline case where D1 and D2 are equal to D, and L1, L2, and L3 are equal to L, the far field antenna gain is shown by curve 210. If the lengths of the main antenna elements remain equal to L, but the distance D between the antenna elements is reduced, the resonant frequency of the antenna generally shifts to a lower frequency, the gain peak generally decreases, and the gain bandwidth also generally decreases as shown by curve 220. If the distance D between the main elements remains the same as in the baseline case but the lengths of the main antenna elements are increased together, the resonant frequency of the antenna generally shifts to a higher frequency, the gain peak generally decreases, and the gain bandwidth generally increases as shown by curve 230.

FIG. 2 is used merely to show how changing the parameter values of the antenna may affect the antenna performance. One skilled in the art will recognize that the distances between the antenna elements 130, 140, 150 do not have to be equal, nor do the lengths of the antenna elements 130, 140, 150 have to be equal. A range of values for each of the parameters may still yield an antenna with acceptable performance. In practice, one of the antenna elements 130 and 150 substantially parallel to the driven element 140 will act as a reflector and the other one will act as a director. The reflector element should have a longer length than the director element.

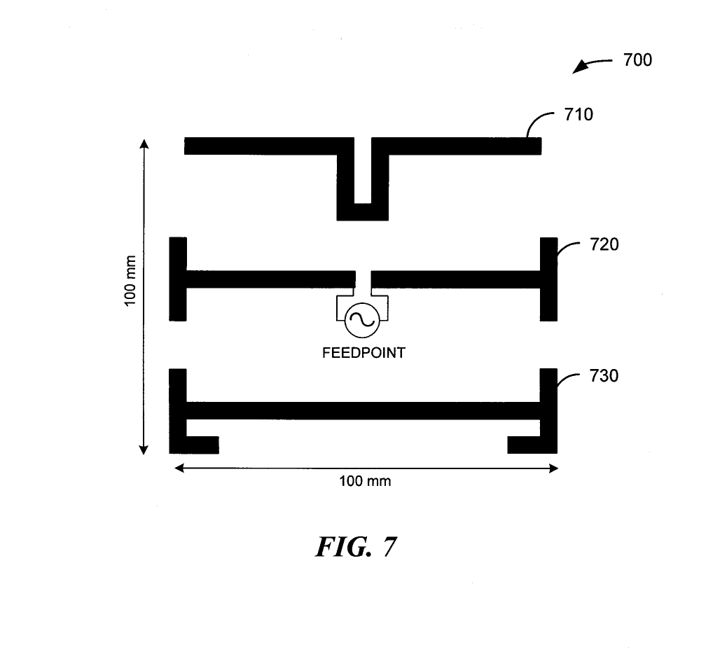

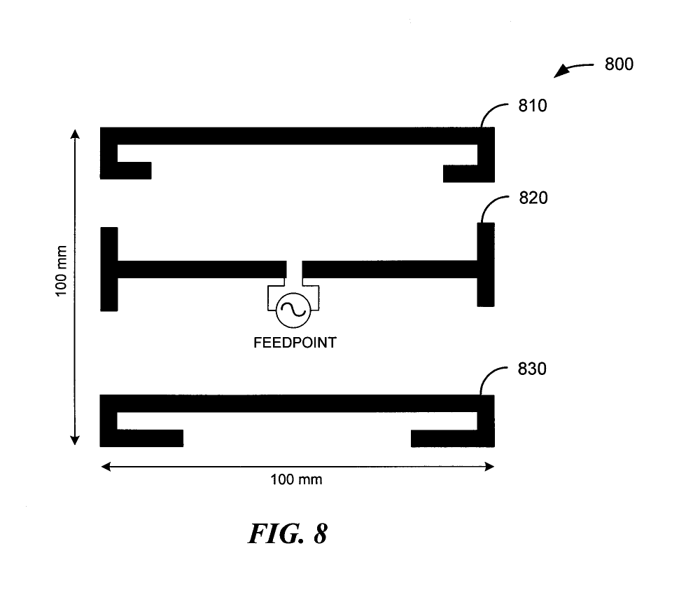

Two antenna configurations 700 and 800 are shown in FIGS. 7 and 8, respectively. Based upon a limited area available for mounting the antenna (100 mm×100 mm) and a requirement that the antenna gain be maximized in the UHF frequency band around 900 MHz, three main antenna elements were selected for each of the antenna designs, a reflector element, a driver element, and a director element. In both embodiments, the antenna is linearly polarized. It will be apparent to one skilled in the art that more than three elements may be used to achieve a higher gain and an unfolded antenna configuration greater than 100 mm by 100 mm may still be suitable for a handheld RFID reader. Each of the additional main elements beyond three may be either reflectors located on the same side of the driven element as the first reflector element or directors located on the same side of the driven element as the first director element.

In both FIG. 7 and FIG. 8, the distances between the main antenna elements are approximately equal. That is, the distance between element 710 and element 720 is substantially equal to the distance between element 720 and element 730 in FIG. 7. Likewise, the distance between element 810 and element 820 is substantially equal to the distance between element 820 and element 830 in FIG. 8. Also, in both figures the bottom element 730 and 830 is the reflector and the top element 710 and 810 is the director because the length of the conducting bottom element 730 and 830 is longer than the respective conducting top element 710 and 810. If more directors are used in an antenna design, the distance between the subsequent directors may or may not be equal to the distance between the first director and the driven element.

In the antenna designs, the reflector, the driven element, and the directors may be terminated on one end or both ends by stub elements or may not be terminated by any stub elements. Also, the reflector and directors may or may not include a meander element, whether located at the center or off center, or pairs of meander elements located symmetrically about the center. However, at least one stub element or one meander element will be needed in the antenna array in order to establish the desired resonant frequency requirement of the antenna system.

In FIG. 7, the director element 710 is not terminated with any stub elements but includes a meander element. The reflector 730 does not include a meander element. Both the driven element 720 and the reflector 730 are terminated by two stub elements, and the stub elements on both ends of each antenna element 720 and 730 are mirror images of each other. However, there is no requirement that the stub elements on the ends of a main antenna element be mirror images. Non-mirror image stub elements would create a non-symmetrical radiation in free space, but may be useful for correcting the radiation pattern of an RFID reader antenna which is not symmetrical in practice.

In FIG. 8, each of the antenna elements 810, 820, 830 are terminated by two stub elements which are mirror images of each other. Neither the reflector 830 nor the director 810 include a meander element.

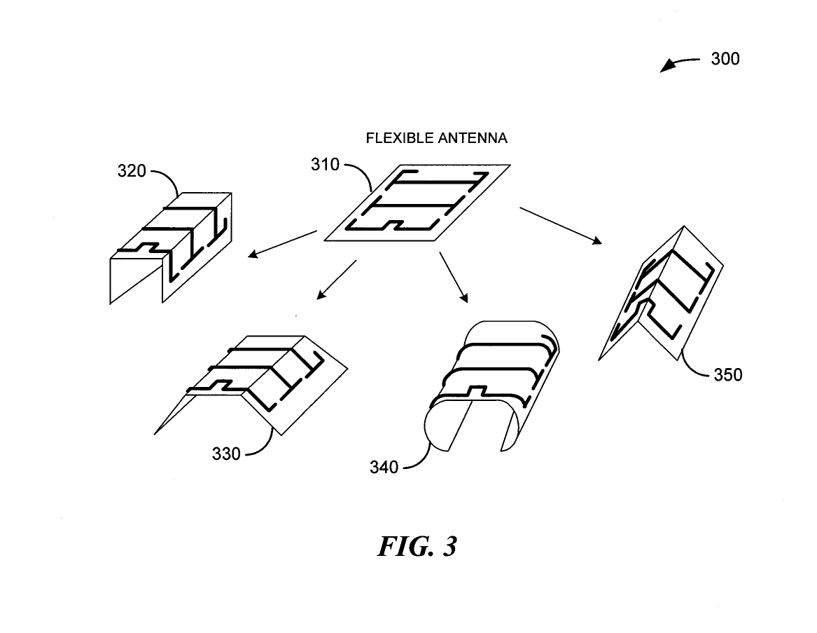

By printing a two-dimensional configuration of the antenna design, examples of which are shown in FIGS. 1, 7, and 8, upon a flexible substrate, the antenna can be curved or bent into different shapes. A flexed antenna reduces the projected area of the antenna without sacrificing antenna performance. Moreover, the flexed antenna shapes allow the antenna to be easily integrated into a variety of industrial design forms for RFID readers. Examples 300 of a two-dimensional antenna design flexed into different shapes are shown in FIG. 3. A basic two-dimensional antenna configuration 310 is bent into shapes 320, 330, 340, and 350. In practice, sharp angles should be avoided. At one extreme, if the antenna is folded in half down the middle, perpendicular to the main antenna elements, the currents flowing on one side of the main antenna elements will cancel the currents flowing on the other side of the main antenna elements and yield very little gain.

Shape 320 is obtained by making right-angle folds in the antenna substrate. Although the antenna will still provide gain because each of the three sections located between bends of the antenna act as a phased antenna array, the gain will be reduced as compared to an antenna folded with acute angles, for example shapes 330 and 350. Shape 340 is obtained by curving the antenna substrate and will offer the best antenna gain performance because there are no sharp transitions. In general, to obtain optimum performance, the antenna should be bent or curved along an axis substantially perpendicular to the main antenna elements, the bends of the antenna substrate should be symmetrical, and the angle of the substrate bends should be minimized, preferably 45° or less.

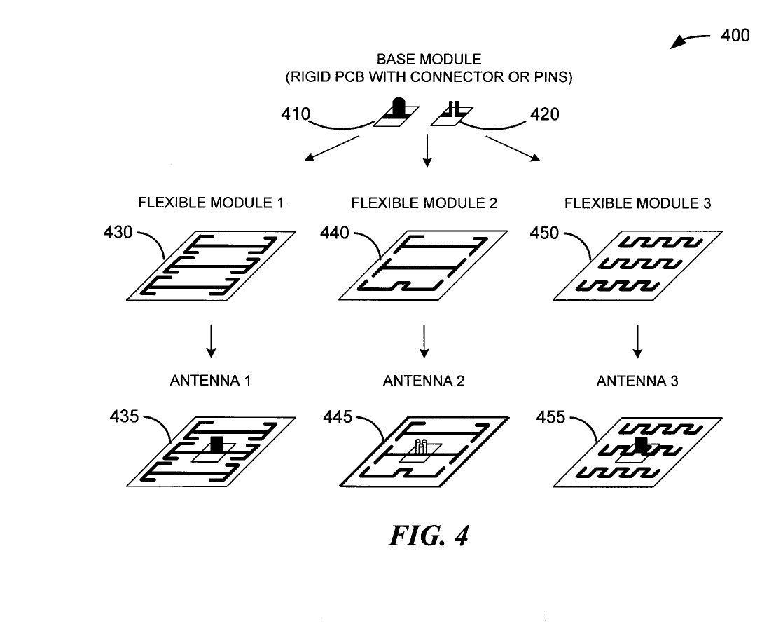

The antenna can also be constructed from several pieces in a modular fashion, where the pieces may be soldered together or merely make electrical contact. FIG. 4 illustrates examples 400 of base modules 410 and 420 where a rigid printed circuit board is used to support an RF connector. The RF connector includes, but is not limited to, any type of RF coaxial connector and RF connector pins, for example pogo pins, for a balanced impedance RF signal source. Electrical contact is made between the base module 410 or 420 and one of the flexible modules 430, 440, 450 to produce an antenna 435, 445, 455. The RF connector is the feedpoint at which the output of an RF generating circuit is applied to the driven element of the antenna array.

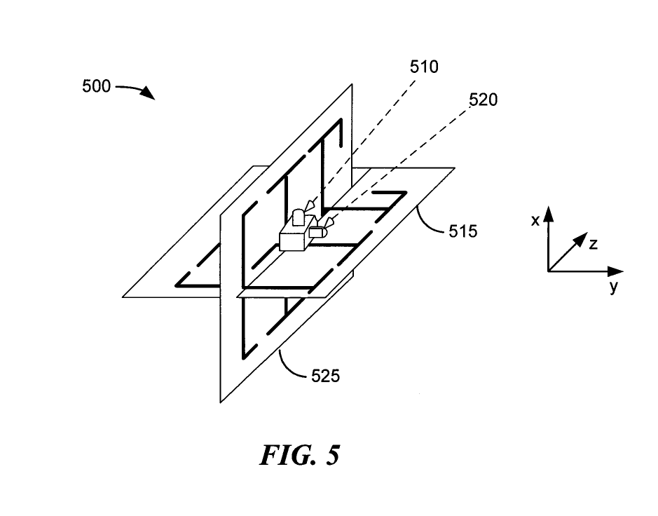

The antennas 435, 445, 455 shown FIG. 4 produce linear polarization. The direction of the linear polarization corresponds to the orientation of the radiating elements in the antenna. The antenna polarization may be changed by appropriately orienting two linearly polarized antenna arrays relative to each other and using appropriate electronic circuitry at the feedpoints. FIG. 5 shows an example 500 of a combination of two antenna arrays used to generate cross-polarization or circular polarization. Two antenna arrays 515 and 525, as described above, are coupled to each other, but not electrically connected, at the center axis of each array and mounted at substantially right angles. Antenna array 515 is fed through a first port 510, and antenna array 525 is fed through a second port 520. For the specific orientation of the combined antennas shown in FIG. 5, antenna array 515 produces linear polarization vertically, along the x-axis, and antenna array 525 produces linear polarization horizontally, along the y-axis. The two antenna arrays 515 and 525 may be, but are not required to be, identical.

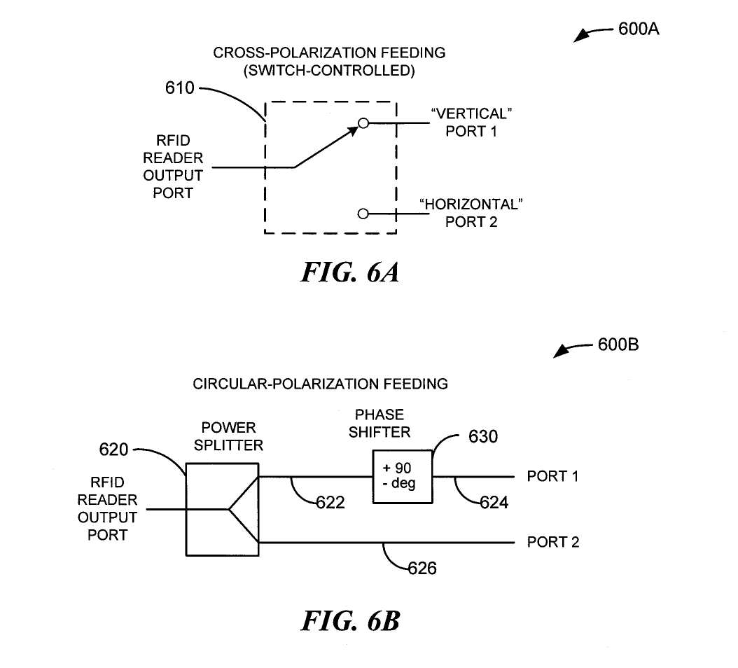

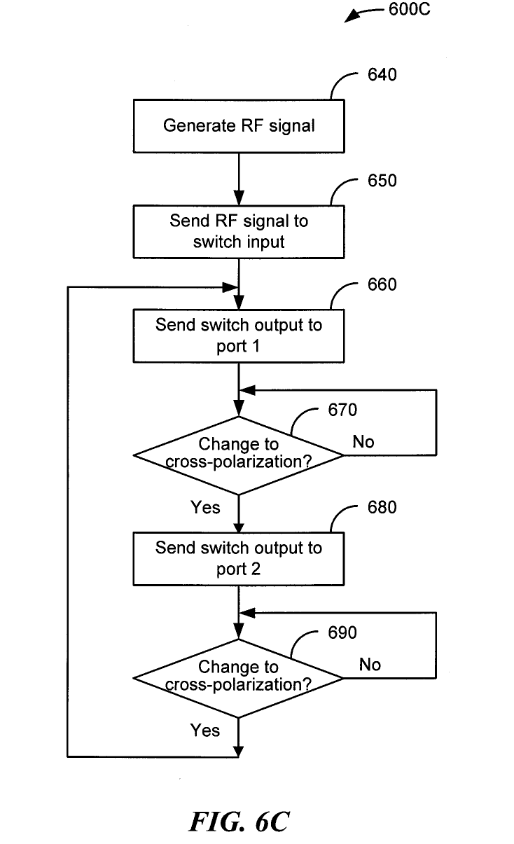

By alternating feeding between the antenna arrays 515 and 525, the polarization of the combined antenna may be switched between vertical and horizontal polarizations to read tags in various orientations. FIG. 6A shows an example 600A of the connections for a simple changeover switch 610 for controlling cross-polarization feeding of the coupled antennas 500. It will be apparent to a person skilled in the art that other switches or switch configurations may be used to perform the same functions as the simple changeover switch 610. The RF generating circuit used to drive the antennas is provided as an input to the switch 610 on the left. The switch 610 is then controlled such that the output of the switch 610 is swapped between switch output port 1 which is coupled to port 510 of the combined antenna 500 and switch output port 2 which is coupled to port 520 of the combine antenna 500. The configuration of switch 610 may be set to change between RFID tag readings or during the search for RFID tags to be read. It may be advantageous to switch the feeding of the two antenna configurations while searching for an RFID tag because there may be reflections from conductive surfaces in the environment which would change the polarization experienced by the tags in the far field of the reader.

In the example of FIG. 6C, the flowchart 600C starts at block 640 where an RF signal is generated by an RF generating circuit. The flowchart 600C continues to block 650 where the output of the RF generating circuit is sent to the input of a switch 610. At block 660, the switch 610 is configured to connect the switch input to output port 1 which is coupled to the driven element of a first linearly polarized antenna array.

If at decision block 670, it is determined (670—No) that the polarization of the combined antenna array should not be changed to the cross polarization, the flowchart remains at decision block 670 until it is determined that the polarization should be changed. If at decision block 670, it is determined (670—Yes) that the polarization of the combined antenna array should be changed to the cross polarization, the flowchart continues to block 680 where the switch 610 is configured to connect the switch input to switch output port 2 which is coupled to the driven element of a second linearly polarized antenna array.

If at decision block 690, it is determined (690—No) that the polarization of the combined antenna array should not be changed back to the other cross polarization, the flowchart remains at decision block 690 until it is determined that the polarization should be changed. If at decision block 690, it is determined (690—Yes) that the polarization of the combined antenna array should be changed back to the cross polarization, the flowchart continues to block 660 where the switch 610 is configured to connect the switch input to switch output port 1 which is coupled to the driven element of the first linearly polarized antenna array.

The flowchart may continue in this manner while the RFID reader is in operation. Alternatively, the polarization of the combined antenna arrays may be switched at periodic intervals between the two cross polarizations. Then, the decisions made at decision blocks 670 and 690 would be time-dependent. That is, if a suitable time period has elapsed, the polarization would be changed to the cross polarization by connecting the input of the switch 610 to the other output port.

FIG. 6B shows a block diagram 600B of the elements needed for generating circular polarization from the combined antennas. Some RFID tags may only respond to one type of circular polarization. Thus, it is important to have an RFID reader capable of generating both types of circular polarization. The RF generating circuit used to drive the antennas is provided as an input to a power splitter 620. Substantially half of the power is sent to path 622 and the remaining power is sent to path 626 which couples directly to switch output port 2 which is coupled to port 520 of the combined antenna 500. Path 622 enters a phase shifter 630. The phase shifter 630 may shift the signal +90° or −90° and outputs the shifted signal to path 624 which couples directly to switch output port 1 which is coupled to port 510 of the combined antenna 500. The 90° phase shift between the signal at path 624 and path 626 results in a polarization of the combined antenna 500 of either right-hand circular polarization or left-hand circular polarization. A +90° phase shift of the signal sent to port 510 of the combined antenna 500, will result in right-hand circular polarization, and a −90° phase shift, will result in left-hand circular polarization. A person skilled in the art will recognize that other methods of generating two approximately equal amplitude signals having a phase shift of approximately +90° or −90° between them may be implemented to perform the same functions as the block diagram 600B.

If the antennas 515 and 525 provide different gains, the circular polarization will effectively be elliptical polarization. Alternatively, if the phase shift provided by the phase shifter 630 is greater than or less than ±90° or a multiple thereof, the antenna will have elliptical polarization.

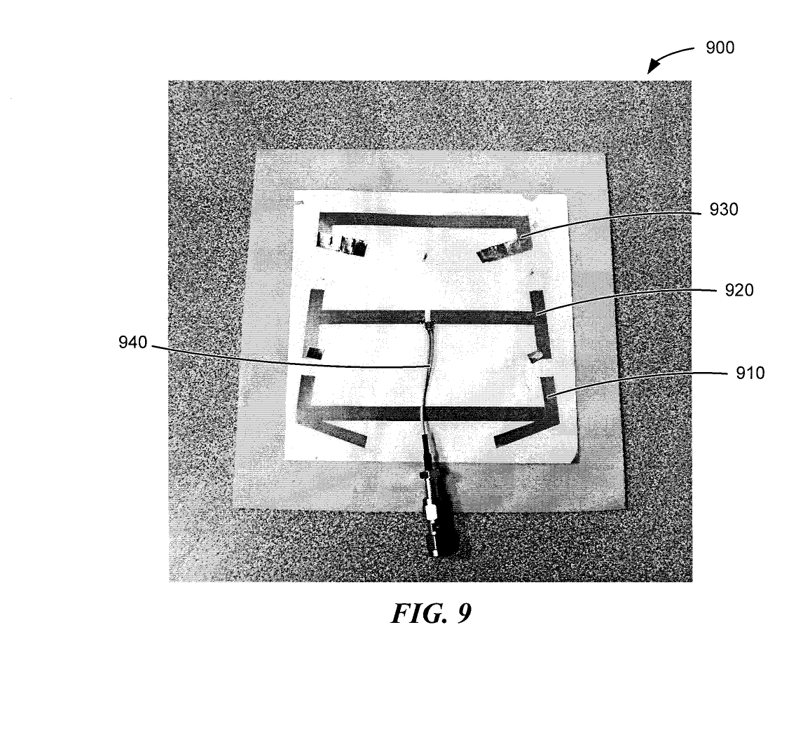

FIG. 9 shows a prototype 900 of the compact flexible high gain antenna for a handheld RFID reader which was constructed. In an unfolded two-dimensional configuration, it occupies approximately 100 mm by 100 mm. The conducting antenna traces were printed using 1-mil-thick copper on 2-mil thick-PET, a thermoplastic polymer, and placed on top of a 60-mil-thick layer of Santoprene, a flexible dielectric material. Methods of forming the traces include, but are not limited to, printing the traces through a deposition process and etching away electrically conductive material deposited upon a dielectric substrate where the remaining material forms the traces. It will be apparent to a person skilled in the art that different thicknesses for the conducting traces and dielectric substrates may be used and that different conducting and dielectric materials may be used with the requirement that the materials be flexible so that the antenna may be bent or curved. The bottom element 910 is the reflector, the middle element 920 is the driven element, and the top element 930 is the director. All three of the antenna elements 910, 920, 930 were terminated at both ends by stub elements. The stub elements were formed using pieces of copper tape in the prototype. No meander elements were used in this design.

The conducting elements of the antenna can be manufactured most easily by printing conducting traces on a dielectric substrate. However, it will be apparent to a person skilled in the art that other methods are available for forming the antenna on a flexible substrate including, but not limited to, using conductive tape, affixing conductive elements in the form of rods or sheets through the use of an adhesive to a flexible substrate or sandwiching conductive elements between two sheets of dielectric material.

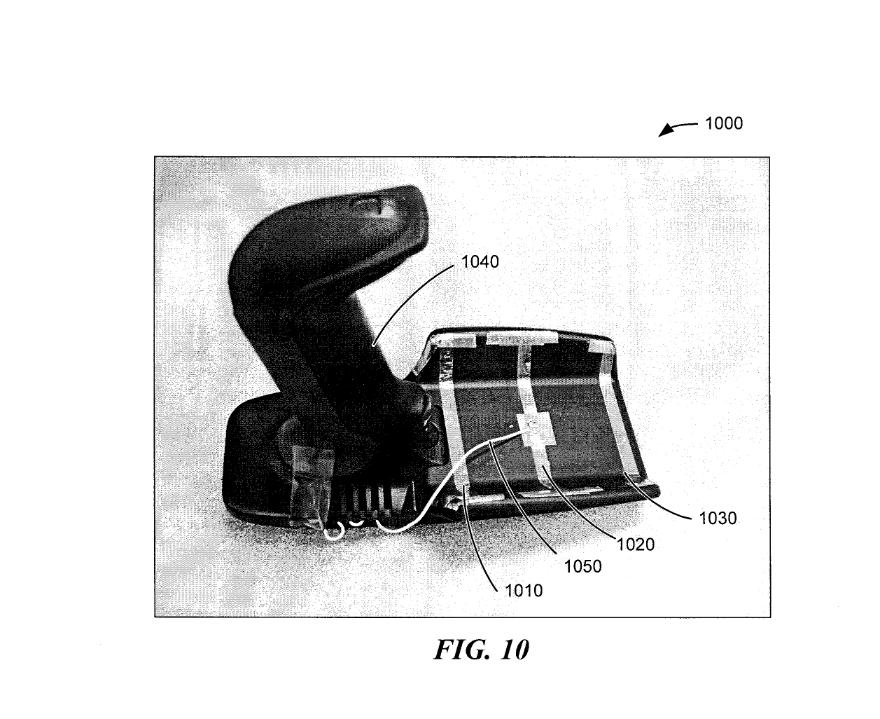

FIG. 10 shows an example 1000 of an antenna which has been fitted to the form factor of a particular portable RFID reader, internal production model name IP30 manufactured by Intermec of Everett, Wash. The antenna substrate may be pre-flexed prior to attaching to the RFID reader or pressed into a bent configuration while attaching to the RFID reader by adhesives or other restraining materials such as screws or clips.

The antenna in FIG. 10 was constructed from copper tape rather than printed with copper traces. The reflector 1010 is situated closest to the handle 1040 of the RFID reader. The driving element 1020 is fed though an RF cable 1040. The direction of maximum gain of the directional antenna is out beyond the director 1030. No meander element was included in the reflector 1010 because there was no room for the meander element on the handle-side of the reflector 1010, and the RF feed cable 1050 interfered with positioning a meander element on the driving element-side of the reflector 1010.

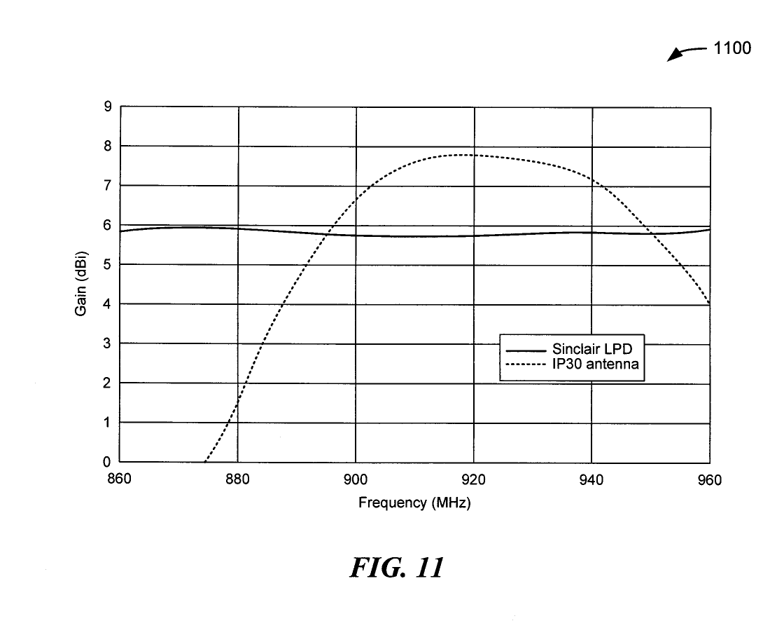

The prototype antenna's gain was measured along the boresight in an anechoic chamber. It is compared to the gain of a Sinclair log-periodic antenna for reference in a graph 1100 shown in FIG. 11. Although the Sinclair antenna is a standard antenna used in the field of microwaves, it is a different class of antenna (log-periodic) and cannot be used in a handheld RFID reader application because the antenna array is too large and heavy. The comparison is being made to show that a larger antenna array such as the Sinclair log-periodic antenna still has a maximum gain of 6 dBi, whereas the compact flexible high gain antenna can approach nearly a maximum of 8 dBi of gain. The tradeoff is that our antenna gives high gain only in a relatively narrow frequency band, e.g. 900-930 MHz, which is all that is needed for an RFID reader, but it is very compact. In contrast, a Sinclair log-periodic antenna array has very broadband gain characteristic (800-1000 MHz) which is why it is used a lot in microwave tests, but it is large and heavy.

While it is important to maximize the gain of the antenna, the FCC has restricted the transmitter power of RFID systems to 1 W (30 dBm) and the equivalent isotropically radiated power (EIRP) to four watts (36 dBm) in order to reduce human exposure to RF fields and to minimize interference with other wireless devices. EIRP is the amount of power that an isotropic antenna would need to emit in order to produce the peak power density observed in the direction of the antenna's maximum gain. This is equivalent to the product of transmitter power and antenna gain relative to isotropic radiated power. Thus, in order to fully utilize the allotted FCC limits, the handheld RFID reader antenna gain should be 6 dBi. By maximizing the allowed antenna gain, the range of operation of the RFID reader is maximized because the range is proportional to the square root of the gain of the RFID reader's antenna. So, for example, an antenna operating with 6 dBi gain would have an operating range 40% farther than an antenna operating with 3 dBi gain.

However, the antenna system requires an extra gain margin to compensate for losses including, but not limited to, cabling losses and variations in the materials or process used to manufacture the antenna. An ideal antenna design would provide for approximately 8 dBi gain. The RFID reader would then include gain-limiting electronics to limit the output power of the reader if the antenna gain is greater than any losses present in the system in order to restrict the EIRP of the system to the FCC limit of four watts.

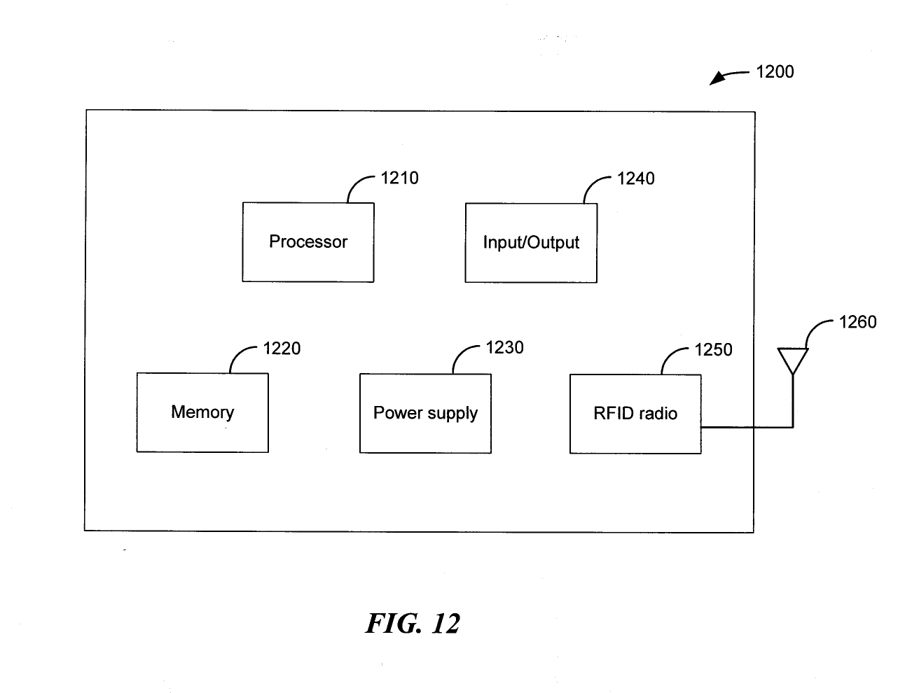

FIG. 12 shows a block diagram 1200 of an RFID reader used to read RFID tags. An RFID reader may include one or more processors 1210, memory units 1220, power supplies 1230, input/output devices 1240, and RFID radios 1250.

A processor 1210 may be used to run RFID reader applications. Memory 1220 may include but is not limited to, RAM, ROM, and any combination of volatile and non-volatile memory. A power supply 1230 may include, but is not limited to, a battery. An input/output device 1240 may include, but is not limited to, triggers to start and stop the RFID reader or to initiate other RFID reader functions, visual displays, speakers, and communication devices that operate through wired or wireless communications. An RFID radio 1250 includes standard components for communication with RFID tags. More importantly, the RFID radio 1250 includes a compact, flexible, high gain antenna 1260 as discussed above.

A compact flexible high gain antenna is disclosed for use in a handheld RFID reader. The antenna includes an array of at least three substantially parallel main conducting elements, a reflector, a driven element, and a director. The driven element is a middle element of the array and is driven by an RF generating circuit. The antenna array is generally linearly polarized.

The resonant frequency and gain bandwidth of the antenna may be tuned by using stub elements to terminate the ends of the main conducting elements or meander elements at the middle portion of any of the main conducting elements except the driven element. The stub elements capacitively load the antenna, and the meander elements inductively load the antenna, thus shifting the impedance of the antenna, and consequently shifting the gain peak and bandwidth.

The antenna may be formed on a flexible substrate so that the antenna may be bent, curved, or partially folded about an axis perpendicular to the main conducting elements. Flexing the substrate allows the antenna to fit desired form factors without significantly affecting the antenna's performance.

In another embodiment, two linearly polarized antenna arrays may be coupled at right angles, each with a separate port for feeding the respective driven elements in the two arrays. The arrays may be fed alternately, thus creating an antenna with cross-polarizations. Alternatively, the antennas may be fed simultaneously with two RF signals, one of which either lags or leads the other signal by 90°. The result is an antenna which generates left-hand or right-hand circular polarization, respectively.

The words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while an RFID reader for reading RFID tags are mentioned, any reading apparatus for reading devices emitting radio-frequency signals may be used under the principles disclosed herein. Further any specific numbers noted herein are only examples: alternative implementations may employ differing values or ranges.

The teachings of the invention provided herein can be applied to other systems, not necessarily the system described above. The elements and acts of the various embodiments described above can be combined to provide further embodiments.

While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

I/We claim:

1. An RFID reader comprising:
one or more processor means to run applications for the RFID reader;
one or more memory means to store information in the RFID reader;
one or more power supply means to power the RFID reader;
one or more input/output means to receive and provide information; and
one or more RFID radio means to read RFID tags that includes a compact flexible high gain antenna, wherein the antenna includes:
three or more substantially parallel traces formed on a flexible dielectric substrate, wherein one of the substantially parallel traces is a driven element fed by an RF generating circuit, and
at least one of the following:
one or more stub element traces terminating one or more ends of the substantially parallel traces for capacitively loading the antenna, and
one or more meander element traces in a central portion of one or more of the substantially parallel traces that is not the driven element for inductively loading the antenna.

2. The RFID reader of claim 1 wherein the flexible substrate is symmetrically bent about an axis substantially perpendicular to the substantially parallel traces.

3. A compact flexible high gain antenna for a handheld RFID reader comprising:
three or more substantially parallel traces formed on a flexible dielectric substrate, wherein one of the substantially parallel traces is a driven element fed by an RF generating circuit, and
at least one of the following:
one or more stub element traces terminating one or more ends of the substantially parallel traces for capacitively loading the antenna, and
one or more meander element traces in a central portion of one or more of the substantially parallel traces that is not the driven element for inductively loading the antenna.

4. The antenna of claim 3, wherein:
the substantially parallel traces are co-planar;
the substantially parallel traces, the stub element traces, and the meander element traces are formed using a conductive material;
the driven element is a middle trace of the substantially parallel traces;
one or more of the substantially parallel traces on a first side of the driven element is shorter than one or more of the substantially parallel traces on a second side of the driven element;
spacings between the substantially parallel traces are substantially equal;
a thickness of the substantially parallel traces, the stub element traces, and the meander element traces is greater than approximately one millimeter and less than approximately ten millimeters;
the flexible substrate is symmetrically bent about an axis substantially perpendicular to the substantially parallel traces, and further wherein an angle of bending is no greater than approximately 45 degrees;
an output of the RF generating circuit is coupled to a first mating end of an RF connector, and a second mating end of the RF connector is electrically coupled to a middle portion of the driven element; and
a transmitted power of the RF generating circuit is less than approximately one watt.

5. The antenna of claim 3 further comprising:
a gain-limiting circuit; and
a base module including a first mating end of an RF connector electrically coupled to a rigid printed circuit board, wherein the printed circuit board is electrically coupled to the driven element and the second mating end of the RF connector is coupled to an output of the RF generating circuit.

6. The antenna of claim 3, wherein the substantially parallel traces, the stub element traces, and the meander element traces are formed using one or more conductive materials.

7. The antenna of claim 3, wherein the driven element is a middle trace of the substantially parallel traces.

8. The antenna of claim 3, wherein one or more of the substantially parallel traces on a first side of the driven element is shorter than one or more of the substantially parallel traces on a second side of the driven element.

9. The antenna of claim 3, wherein one or more thicknesses of the substantially parallel traces, the stub element traces, and the meander element traces is greater than approximately one millimeter and less than approximately ten millimeters.

10. The antenna of claim 3, wherein spacings between the substantially parallel traces are substantially equal.

11. The antenna of claim 3, wherein the flexible substrate is bent to form a three-dimensional configuration.

12. The antenna of claim 3, wherein the flexible substrate is symmetrically bent about an axis substantially perpendicular to the substantially parallel traces and an area occupied by the antenna is less than four square inches prior to bending.

13. The antenna of claim 3 further comprising electronic circuitry to limit the power transmitted by the antenna.

14. The antenna of claim 3 further comprising a base module including a first mating end of an RF connector electrically coupled to a rigid supporting material, wherein the rigid supporting material is electrically coupled to the driven element and the second mating end of the RF connector is coupled to an output of the RF generating circuit.

15. A process for manufacturing a compact flexible high gain antenna for a handheld RFID reader comprising:
forming conducting antenna traces on a flexible substrate, wherein the conducting antenna traces include at least three co-planar substantially parallel traces and at least one of the following: one stub element at an end of at least one of the substantially parallel traces and one meander element at a middle portion of one of the substantially parallel traces that is not coupled to an RF connector;
forming an electrical contact between one of the substantially parallel antenna traces and the RF connector;
bending the flexible substrate into a three-dimensional configuration; and
attaching the flexible substrate to the RFID reader.

16. The process of claim 15 further comprising means for coupling the RF connector to an RF generating circuit and means for attaching the RF connector to a rigid substrate.

17. The process of claim 15, wherein the flexible substrate is symmetrically bent about an axis substantially perpendicular to the substantially parallel traces.

18. A compact flexible high gain circular polarization antenna for a handheld RFID reader comprising:
a first antenna array coupled to a second antenna array, wherein each array comprises three or more substantially parallel conducting traces formed on a flexible substrate, and one of the substantially parallel traces is a driven element fed by an RF generating circuit, and further wherein the substantially parallel conducting traces of each array are substantially perpendicular to each other;
one or more stub elements terminating one or more ends of the substantially parallel traces of each array or one or more meander elements at a center of one or more of the substantially parallel traces of each array that is not the driven element; and
a splitter to divide the output of the RF generating circuit into a first portion and a second portion, wherein the first portion is shifted substantially 90 degrees from the second portion and fed to the driven element of the first antenna array, and the second portion is fed to the driven element of the second antenna array.

19. The antenna of claim 18 wherein a center axis of the first antenna array is coupled to a center axis of the second antenna array.

20. The antenna of claim 18 wherein each antenna array is bent into a three-dimensional configuration.

21. A compact flexible high gain cross-polarization antenna for a handheld RFID reader comprising:
a first antenna array rigidly coupled to a second antenna array, wherein each array comprises three or more substantially parallel conducting traces formed on a flexible substrate, and one of the substantially parallel traces is a driven element, and further wherein the substantially parallel conducting traces of each array are substantially perpendicular to each other;
one or more stub elements terminating one or more ends of the substantially parallel traces of each array or one or more meander elements at the center of one or more of the substantially parallel traces of each array that is not a driven element; and
a switch element for directing an output of an RF generating circuit to the driven element of the first antenna array or the driven element of the second antenna array.

22. The antenna of claim 21 wherein each antenna array is bent into a three-dimensional configuration.

23. The antenna of claim 21 wherein the first array is identical to the second array.

24. A method for generating alternating cross-polarizations in a compact flexible high gain antenna for a handheld RFID reader comprising:
generating an RF signal;
applying the RF signal to an input of a switch having a first output and a second output, wherein the first output is coupled to a first antenna array formed on a first flexible substrate and produces substantially linear polarization in a first direction, and the second output is coupled to a second antenna array formed on a second flexible substrate and produces substantially linear polarization in a second direction, and further wherein the first antenna array and the second antenna array are rigidly coupled; and
directing the input of the switch alternately to the first output and the second output.

25. The method of claim 24 wherein the first direction is substantially perpendicular to the second direction.

26. The method of claim 24 wherein directing the input of the switch alternately to the first output and the second output is periodic.
